(19) United States
(12) Patent Application Publication
(10) Pub. No.: US 2023/0272972 A1
(43) Pub. Date: Aug. 31, 2023

(54) SOLAR TOWER TO DRY ORGANIC MATTER ON A LARGE SCALE

(71) Applicant: ARIZONA BOARD OF REGENTS ON BEHALF OF THE UNIVERSITY OF ARIZONA, Tucson, AZ (US)

(72) Inventor: Goggy Davidowitz, Tucson, AZ (US)

(21) Appl. No.: 18/043,694

(22) PCT Filed: Sep. 1, 2021
(86) PCT No.: PCT/US21/48651

§ 371 Date: Mar. 1, 2023

Related U.S. Application Data
(60) Provisional application No. 63/073,150, filed on Sep. 1, 2020.

(51) Int. Cl. F26B 3/28; F26B 17/08; F24S 20/30

(52) U.S. Cl. CPC F26B 3/286; F26B 17/08; F24S 20/30; F26B 2200/02; F26B 2200/12; F24S 60/00

(57) ABSTRACT

The present invention is directed to time and energy efficient drying of organic matter. The present invention features a drying system which may include a solar tower, a shredder, and an input conveyor for transporting the organic matter to conveyors positioned in a cascading configuration. The system may further include sensors for collecting information, and a control system for receiving the information to determine a speed of the conveyors. The system may further include an output conveyor for transporting the organic matter from the conveyors to a storage. The system may further include water condensers to reclaim water evaporated from the organic matter to be stored and repurposed. The system may further include a solar power system for converting sunlight into power for the system. Sunlight may cause a thermal gradient within the solar tower, causing air in an upper portion to be hotter than air in a lower portion.

### CROSS-REFERENCES TO RELATED APPLICATIONS

This application claims benefit of U.S. Patent Application No. 63/073,150, filed Sep. 1, 2020, the specification of which is incorporated herein in its entirety by reference.

### FIELD OF THE INVENTION

The present invention is directed to time and energy efficient drying of organic matter on a large scale.

### BACKGROUND OF THE INVENTION

In the United States alone, a staggering 62.1 billion pounds of fruit, vegetable, and grain products end up in the landfill each year. This amounts to an economic loss of $75.5 billion. Some of the food waste is of high quality that, for a variety of reasons, has not made it into the supply chain. Other waste can be repurposed into a saleable commodity such as feed or fertilizer. The biggest constraint on salvaging this food waste is time: processing the food waste before it rots. Solar drying to preserve vegetables and other agricultural products has been in use since prehistoric times. More modern use of greenhouses to increase drying rate typically have a single layer of drying plant material at bench or ground height. This is adequate for small batches of agricultural produce, but not sufficient to handle large-scale drying. Industrial scale food drying technology using drum-dryers or spray-dryers are fast but require huge energy inputs and are cost prohibitive. Thus, a present need exists for a time and energy efficient device that allows for drying of food waste on a large scale. Additionally, there exists a need for efficient drying devices and methods for other organic matter, such as agricultural products, food waste, and manure.

### BRIEF SUMMARY OF THE INVENTION

It is an objective of the present invention to provide systems, devices, and methods that allow for time and energy efficient drying of organic matter on a large scale, as specified in the independent claims. Embodiments of the invention are given in the dependent claims. Embodiments of the present invention can be freely combined with each other if they are not mutually exclusive.

The present invention features a system for drying organic matter on a large scale. The system may comprise a solar tower, a shredder for shredding the organic matter, an input conveyor for transporting the organic matter into the solar tower, and a plurality of conveyors having variable speed capabilities within the solar tower. The solar tower may be clad in transparent (translucent) covering (similar to greenhouse covering) that allows solar radiation to enter the tower but traps the heat inside. The input conveyor may transport the organic matter to a highest conveyor of the plurality of conveyors, and the plurality of conveyors may be positioned in a cascading configuration, such that organic matter drops through the plurality of conveyors to reach a lowest conveyor. Without wishing to limit the present invention to any particular theory or mechanism, it is believed that one purpose of the cascading configuration is to tumble the organic matter to ensure all facets of the organic matter are exposed to the air to maximize drying efficiency. The system may further comprise a plurality of sensors for collecting information, and a control system for receiving the information from the plurality of sensors and using the information to determine a speed of the plurality of conveyors. The system may further comprise an output conveyor for transporting the organic matter from the solar tower to an external storage. The lowest conveyor of the plurality of conveyors may transport the organic matter to the output conveyor. The system may further comprise a solar power system for converting sunlight into power for the system. Sunlight may cause a thermal gradient within the hollow interior, causing air in an upper portion of the hollow interior to be hotter than air in a lower portion of the hollow interior.

The present invention features a method for drying organic matter on a large scale. The method may comprise placing the organic matter on an input conveyor and transporting, by the input conveyor, the organic matter onto a highest conveyor of a plurality of conveyors within a solar tower. The plurality of conveyors may be positioned in a cascading configuration, such that organic matter drops through the plurality of conveyors to reach a lower conveyor. The method may further comprise collecting information by a plurality of sensors and determining, by a control system, a speed of the plurality of conveyors based on the information provided by the plurality of sensors. The method may further comprise transporting the organic matter across each conveyor of the plurality of conveyors onto an output conveyor, and transporting, by the output conveyor, the organic matter from within the solar tower to an external storage. A solar power system may convert sunlight into power for the system. Sunlight may cause a thermal gradient within the hollow interior, causing air in an upper portion of the hollow interior to be hotter than air in a lower portion of the hollow interior.

The design of the present invention maximizes the temperature gradient within the tower to minimize drying time. The solar dryer uses solar radiation, requiring minimal energy input. Drying the fruit and vegetable waste reduces its volume and weight by over 95%. These reductions can reduce shipping costs and preserve landfill space. Fruits and vegetables contain over 95% water. Dehumidifiers reclaim this water from the air inside the tower and store it in external water tanks where it can be repurposed and reused such as in irrigation. One ton of food waste will produce nearly one cubic meter of reusable water. The dried food waste can be stored and used as needed to fertilize fields, feed livestock, or sold as a commodity turning a waste stream into a revenue stream.

One of the unique and inventive technical features of the present invention is the use of cascading, solar-powered, variable-speed conveyor belts within a solar tower. Without wishing to limit the invention to any theory or mechanism, it is believed that the technical feature of the present invention advantageously provides for an energy efficient way to dry organic matter on a large scale at different rates depending on a plurality of factors. None of the presently known prior references or work has the unique inventive technical feature of the present invention. Current usage of greenhouse-type structures to dry food typically requires a single static layer, limiting the volume of food that can be processed. The unique use of a continuous conveyor system, coupled with a thermal gradient allows for more rapid processing of higher volumes.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWINGS

The features and advantages of the present invention will become apparent from a consideration of the following detailed description presented in connection with the accompanying drawings in which:

FIG. 1 shows a diagram of a system for drying organic matter on a large scale. The system has multiple conveyors which transport the organic matter through a solar tower.

FIG. 2 shows a flow chart of a method for drying food waste on a large scale.

FIG. 3 shows a diagram of a system for drying organic matter on a large scale. The system has a spiral conveyor which transports the organic matter through a solar tower.

### DETAILED DESCRIPTION OF THE INVENTION

Following is a list of elements corresponding to a particular element referred to herein:

100 food drying system

110 solar tower

120 shredder

200 input conveyor

210 conveyor

215 bumper

220 sensor

225 mixing component

230 output conveyor

300 solar panel

310 thin-film photovoltaics

400 water condenser

410 water storage

500 fan

600 heat sink

As used herein, the term “organic matter” is used to refer to any biologically relevant matter, such as matter produced by living organisms. Non-limiting examples of organic matter include agricultural crops or products, spices, coffee beans, meat, fish, insects, fruits, vegetables, food waste, or manure.

As used herein, the term “conveyor” refers to a device designed for transportation of matter, typically in a horizontal, vertical, diagonal, or rotational direction. Non-limiting examples of conveyors include conveyor belts, roller conveyors, chain conveyors, screw or auger conveyors, chutes, horizontal conveyors, vertical conveyors, spiral conveyors, and vibrating conveyors.

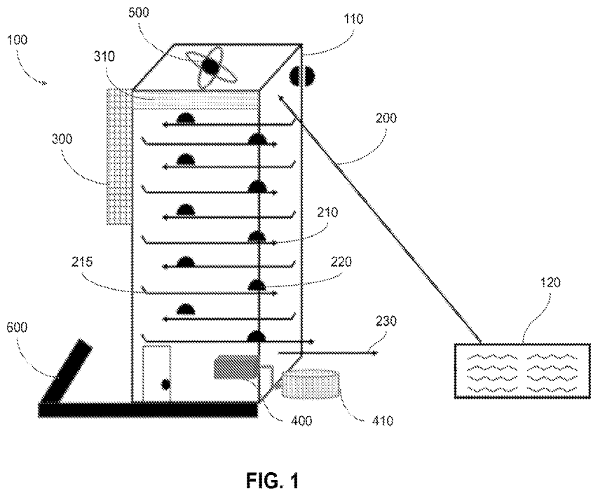

Referring now to FIG. 1, the present invention features a system (100) for drying organic matter on a large scale. The present invention may also feature systems for drying matter that is inorganic, such as sludge. In some embodiments, the system (100) may comprise a transparent or translucent solar tower (110) comprising a hollow interior to allow components to be disposed within the solar tower (110). The system (100) may further comprise a shredder (120) for increasing surface area of the organic matter, an input conveyor (200) for transporting the organic matter to the hollow interior of the solar tower (110), and a plurality of conveyors (210) having variable speed capabilities disposed within the solar tower (110). The input conveyor (200) may transport the organic matter to a highest conveyor of the plurality of conveyors (210). The plurality of conveyors (210) may be positioned in a cascading configuration, such that when the organic matter reaches an end of an upper conveyor of the plurality of conveyors (210), the organic matter drops onto a lower conveyor of the plurality of conveyors (210). The system (100) may further comprise a plurality of sensors (220) disposed on or near the plurality of conveyors (210), within the solar tower (110), and on an exterior of the solar tower (110) for collecting information. The system (100) may further comprise a control system operatively connected to the plurality of sensors (220) and the plurality of conveyors (210) for receiving the information from the plurality of sensors (220) and using the information to determine a speed of the plurality of conveyors (210). The system (100) may further comprise an output conveyor (230) for transporting the organic matter from the hollow interior of the solar tower (110) to an external storage. The lowest conveyor of the plurality of conveyors (210) may transport the organic matter to the output conveyor (230). The system (100) may further comprise a solar power system for converting sunlight into power for the input conveyor (200), the plurality of conveyors (210), the output conveyor (230), the plurality of sensors (220), and the control system. Sunlight may cause a thermal gradient within the hollow interior, causing air in an upper portion of the hollow interior to be hotter than air in a lower portion of the hollow interior.

In some embodiments, the information collected by the plurality of sensors (220) comprises temperature inside and outside the solar tower (110), relative humidity, and water content of the organic matter. A cool temperature, a high relative humidity, a high water content of the organic matter, or a combination thereof may cause the control system to lower the speed of the conveyors thereby increasing drying time. A high temperature, a low relative humidity, a low water content of the organic matter, or a combination thereof may cause the control system to increase the speed of the conveyors. In some embodiments, the system (100) may further comprise a water condenser (400) disposed within the solar tower (110) for dehumidifying ambient air within the solar tower (110). The water condenser (400) may be connected to an external water storage (410) and is powered by the solar power system. In some embodiments, the system (100) may further comprise a plurality of bumpers (215) disposed on the plurality of conveyors (210) for guiding the organic matter. In some embodiments, the system (100) may further comprise a variable speed fan (500) disposed at an upper surface within the solar tower (110) operatively connected to the control system and powered by the solar power system for distributing hot air throughout the solar tower (110). In some embodiments, the system (100) may further comprise a heat sink (600) disposed adjacent to an external surface of the solar tower (110) for trapping additional radiant heat to be released into the solar tower (110) after sunset to prolong drying time. In some embodiments, the system (100) may further comprise a covering disposed about an external surface of the solar tower (110) for trapping heat within the solar tower (110). The solar power system may comprise solar panels (300), thin-film photovoltaics (310), or a combination thereof.

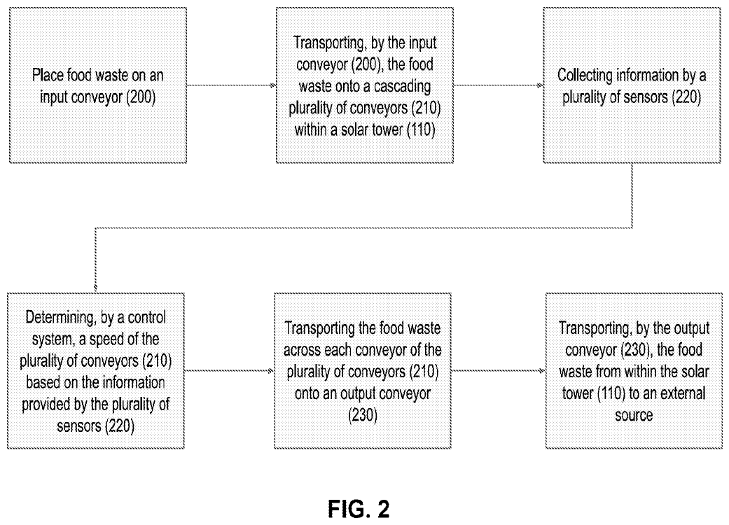

Referring now to FIG. 2, the present invention features a method for drying food waste or other organic matter on a large scale. In some embodiments, the method may comprise placing the food waste on an input conveyor (200). The method may further comprise transporting, by the input conveyor (200), the food waste onto a highest conveyor of a plurality of conveyors (210) within a solar tower (110). The plurality of conveyors (210) may be positioned in a cascading configuration, such that when the food waste reaches an end of an upper conveyor of the plurality of conveyors (210), the food waste drops onto a lower conveyor of the plurality of conveyors (210). The method may further comprise collecting information by a plurality of sensors (220) disposed on the plurality of conveyors (210), within the solar tower (110), and on an exterior of the solar tower (110) for collecting information. The method may further comprise determining, by a control system operatively connected to the plurality of sensors (220) and the plurality of conveyors (210), a speed of the plurality of conveyors (210) based on the information provided by the plurality of sensors (220). The method may further comprise transporting the food waste across each conveyor of the plurality of conveyors (210) onto an output conveyor (230), and transporting, by the output conveyor (230), the food waste from within the solar tower (110) to an external storage. A solar power system may convert sunlight into power for the input conveyor (200), the plurality of conveyors (210), the output conveyor (230), the plurality of sensors (220), and the control system. Sunlight may cause a thermal gradient within the hollow interior, causing air in an upper portion of the hollow interior to be hotter than air in a lower portion of the hollow interior.

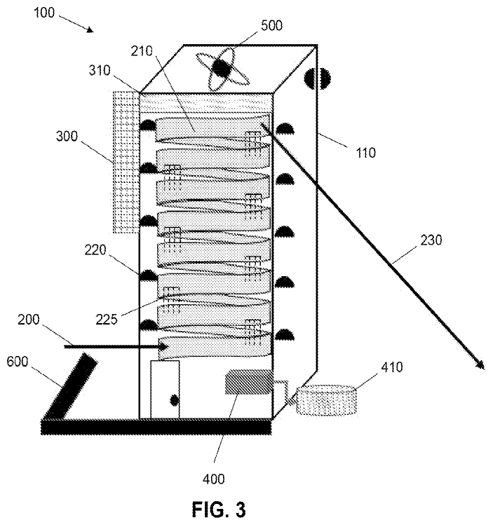

Referring now to FIG. 3, the present invention may feature a system (100) for drying organic matter in which the conveyor system is a single continuous spiral conveyor with an input for the organic matter at the lowest level, which transports the organic matter through the thermal gradient to a highest point in the tower, at which point the waste is conveyed via a slide or chute to a collecting bin outside the tower. In this non-limiting example, a mechanical mixer or tumbler such as a series of chains hanging from the level above serves to tumble the waste on the spiral conveyor to ensure drying efficiency. FIG. 3 shows a solar power system which includes a combination of solar panels (300) and thin-film photovoltaics (310). FIG. 3 also shows sensors (220) inside and outside the solar tower (110) which may be used to inform a control system which controls the conveyors and fan (500).

In some embodiments, the information collected by the plurality of sensors (220) may comprise temperature inside and outside the solar tower (110), relative humidity, and water content of the organic matter. A cool temperature, a high relative humidity, a high water content of the organic matter, or a combination thereof causes the control system to lower the speed of the conveyors. A high temperature, a low relative humidity, a low water content of the organic matter, or a combination thereof causes the control system to increase the speed of the conveyors. In some embodiments, the method may further comprise dehumidifying ambient air within the solar tower (110) using a water condenser (400) disposed within the solar tower (110). The water condenser (400) may be connected to an external water storage (410) and is powered by the solar power system. In some embodiments, the method may further comprise guiding the organic matter using a plurality of bumpers (215) disposed on the plurality of conveyors (210). In some embodiments, the method may further comprise distributing hot air throughout the solar tower (110) using a variable speed fan (500) disposed at an upper surface within the solar tower (110) operatively connected to the control system and powered by the solar power system. In some embodiments, the method may further comprise trapping additional radiant heat to be released into the solar tower (110) after sunset to prolong drying time using a heat sink (600) disposed adjacent to an external surface of the solar tower (110). In some embodiments, the method may further comprise trapping heat within the solar tower (110) using a covering disposed about an external surface of the solar tower (110). The solar power system may comprise solar panels (300), thin-film photovoltaics (310), or a combination thereof.

A higher tower allows for more conveyor belts to be installed and for a greater thermal gradient to be generated. A longer tower allows for longer conveyor belts to be installed to increase retention and drying time. The dimensions and footprint of the drying tower may be adjusted for location and type of product to dry. Higher latitude locations, with cooler climates and more cloud cover may require larger drying towers, either in length or height or a combination thereof, to increase drying time. For covering, standard greenhouse covering can be used under most circumstances. However, in locations with high cloud cover, light condensing covering, such as Fresnel lenses, can be used to generate more heat. The more conveyor belts in the system, the more time the organic matter will have to go through the system. The slower the belts move, the more time the organic matter has to dry. Circulating the hot air to the lower levels with a fan will decrease drying times. The water condensers serve to dehumidify the ambient air in the structure. The dryer the air, the faster the drying time. Larger water condensers can dehumidify larger volumes of air, thereby reducing drying time.

In some embodiments the present invention features a system (100) for drying organic matter such as an agricultural product, food waste, or manure. As a non-limiting example, the system (100) may include a solar tower (110), a conveyor system, and a control system. As used herein, the term “solar tower” refers to a multi-level structure, clad in a transparent or translucent covering, that is partially or entirely heated via solar energy. The covering may cover some or all sides of the solar tower, and may also cover the roof. In some embodiments, the height of the tower may be such that a thermal gradient with a desired temperature difference between an upper portion and a lower portion (or a temperature difference between the upper portion and the exterior of the solar tower) may be obtained. As non-limiting examples, the temperature difference may be greater than 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 45, 50, 55, 60, 65, 70, 75, 80, 85, 90, 95 or 100 degrees Fahrenheit.

In some embodiments, the solar tower includes a structural frame which may be used to support other components of the solar tower. In some embodiments, the solar tower additionally includes a barrier material supported by the structural frame. The barrier material may be opaque, or partially or entirely transparent, rigid or flexible, porous, semi-permeable, or waterproof, fixed or retractable. Non-limiting examples of materials which may be suitable barrier materials include greenhouse film, polycarbonate sheets, acrylic sheets, glass, polymer sheets, corrugated or non-corrugated plastic panels. The barrier material may function to exclude birds, bugs, and other organisms from the interior of the solar tower, and to retain heat and/or moisture. The solar tower may include a permanent foundation, or may be designed with a portable base. In some embodiments, the solar tower may have a height greater than about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 45, 50, 55, 60, 65, 70, 75, 80, 85, 90, 95 or 100 ft.

The barrier material may surround the structural frame or may be supported within the structural frame. The barrier material may form substantially the same shape as the structural frame or may have a different shape. As a non-limiting example, the structural frame may function as a central support which is surrounded by the barrier material in a tent-like configuration. The cross-section of the hollow interior of the solar tower (110) may be uniform from top to bottom, or may be larger at either the bottom or top. The shape of the hollow interior may be selected so as to optimize a thermal gradient within the hollow interior.

In some embodiments, the hollow interior may be directly heated by the incident solar power. A greenhouse effect may contribute to this heating and the generation of a thermal gradient. In some embodiments, one or more reflectors, or solar panels may be used to increase the heating of the tower. In some embodiments, the tower may be heated via geothermal energy, waste heat from industrial processes, wind energy, nuclear energy, hydropower, or energy from biogas. In some embodiments, the temperature within the tower may contribute to the decomposition of organic matter within the tower, thereby releasing additional heat, or biogas which may be harnessed to produce additional heat. In some embodiments, additives such as microorganisms may be included within the organic matter to be dried which will assist in the decomposition of the organic matter.

The hollow interior of the solar tower (110) may allow various components to be disposed within the solar tower (110). In some embodiments, a conveyor system disposed within the solar tower (110) may transport organic matter within the hollow interior of the solar tower (110). The conveyor system may be either partially or entirely disposed within the solar tower (110) and may include one or more conveyors (210) such as a linear conveyor, a spiral conveyor, an elevator, a chute, or a mobile conveyor container. In some embodiments, two or more components of the conveyor system are powered by a shared motor. The organic matter may be in direct contact with the conveyors, or may be placed in containers such as baskets, bins, or cages, which are in contact with the conveyors. One or more of the components of the conveyor system may be powered by solar power. In some embodiments, the entire conveyor system may be solar powered.

The components of the conveyor system convey the organic matter at the same speed or at different speeds. Movement of the organic matter via the conveyor system may be continuous or periodic. The conveyor system may function only to transport the organic matter within the hollow interior (for example, in a closed loop), or may introduce undried organic matter to a drying path, transport the organic matter through the drying path, and then eliminate the dried organic matter. In some embodiments, the amount of time a particular portion of the organic matter spends in the drying path may depend on the initial moisture level of the organic matter, the desired degree of dehydration, and the average temperature and humidity level of the hollow interior. In some embodiments, the hollow interior may include multiple separate or interconnected drying paths. In some embodiments, one or more diverters may be used to divert portions of the organic matter from one drying path to another based on the moisture content of the portion of organic matter. As a non-limiting example, samples may be added and removed from a looped drying path as needed to accomplish a desired degree of dehydration. As another embodiment, samples may be diverted between faster and slower drying paths based on a calculated rate of dehydration.

In preferred embodiments, sunlight causes a thermal gradient within the hollow interior, causing air in an upper portion of the hollow interior to be hotter than air in the lower portion of the hollow interior. The conveyor system may be configured to transport the organic matter from the lower portion of the hollow interior to the upper portion of the hollow interior or from the upper portion of the hollow interior to the lower portion of the hollow interior. In some embodiments, the conveyor system may be configured to transport the organic matter so that it is cycled between the upper portion and the lower portion. The thermal gradient may allow for faster drying in the upper portion and slower drying in the lower portion. For certain applications, it may be advantageous to expose the organic matter to higher temperatures at the beginning of a drying cycle, at the end of a drying cycle, or multiple times during a drying cycle. In some embodiments, a sample may be positioned in the upper portion until it reaches a desired temperature, then lowered to dry in the lower portion. Cycling the organic matter between the upper and lower portions of the hollow interior may additionally provide for mixing of the organic matter as it dries. The system may be configured to dry either a continuous flow of organic matter or multiple distinct batches of organic matter.

In some embodiments, a control system may be operatively connected to the conveyor system. The control system configured to control transportation of the organic matter via the conveyor system such that the organic matter is dried. The control system may be a programable automated system, or may be a manual system to be controlled by an operator. The control system may control flow rates of organic matter on to and off of the conveyor system as well as the rate of the conveyor system. The control system may adjust these rates based on calculated moisture content of the organic matter, temperature and/or humidity within the hollow interior, or other measured values such as from the sensors. Moisture content of the organic matter may be measured in one or more locations via IR monitoring, conductivity, sample weight, sample depth, a wired probe, or any other suitable monitoring method.

In some embodiments, the thermal gradient may cause air circulation through the hollow interior. In some embodiments, the system may include one or more blowers or fans (500). The blowers or fans (500) may be configured to circulate air from the upper portion of the hollow interior to a lower portion of the hollow interior or from the lower portion of the hollow interior to the upper portion of the hollow interior. The one or more blowers or fans (500) may circulate air within the hollow interior of the solar tower (110) or between the hollow interior of the solar tower (110) and an exterior of the solar tower. In some embodiments, the system may include one or more vents in the upper portion and/or the lower portion to allow for air flow in or out of the hollow interior. The vents may be fixed or controllable by the control system. In some embodiments, the blowers or fans (500) may temporarily reduce, eliminate, or reverse the thermal gradient by bringing warmer air from the upper portion to the lower portion or by bringing cooler air from the lower portion to the upper portion. In some embodiments the blowers or fans (500) may aid in the condensation of moisture from the hollow interior.

In some embodiments, the system (100) may be configured to produce usable water. As a non-limiting example, the system (100) may include a moisture collection system for condensing moisture within the hollow interior of the solar tower (110) and transporting the condensed moisture to a water storage (410). Alternatively, the moisture collection system may drain the condensed moisture outside the solar tower. The system may also include one or more water purification components for treating the condensed moisture.

In some embodiments, the system (100) may also include one or more mixing components configured to mix the organic matter as it is transported by the conveyor system. Non-limiting examples of mixing components include chains hanging in the drying path, sample invertors or tumblers, bumpers, vibrators, blowers, agitators, and gravity mixers. In some embodiments, one or more additives may be mixed in with the organic matter so as to assist with the drying process.

In some embodiments, one or more retractable shade cloths covering one or more sides of the drying tower may reduce extreme heat in the upper reaches of the tower such as in lower latitudes or elevations, desert environments, or very hot habitats.

In some embodiments, the present invention features a method for drying organic matter. As a non-limiting example, the method may include: providing a solar tower (110) in which sunlight causes a thermal gradient within the hollow interior, causing air in an upper portion of the hollow interior to be hotter than air in a lower portion of the hollow interior; transporting the organic matter to a conveyor system disposed within the solar tower (110); and transporting the organic matter throughout the hollow interior via the conveyor system such that the organic matter is exposed to the thermal gradient for a sufficient period of time to achieve a desired degree of dehydration.

In some embodiments, the method may also include condensing moisture within the hollow interior and transporting the condensed moisture to a water storage (410) via a moisture collection system. The method may also include, mixing the organic matter via one or more mixers so as to increase the surface area of the organic matter exposed to air within the thermal gradient. The method may also include circulating air within the hollow interior via one or more fans (500), and/or reducing humidity within the hollow interior via a water condenser (400). According to some embodiments, all of the energy required for heating the solar tower may be generated by harnessing solar power.

### EXAMPLE

The following is a non-limiting example of the present invention. It is to be understood that said example is not intended to limit the present invention in any way. Equivalents or substitutes are within the scope of the present invention.

The solar drying tower is a vertical greenhouse 7-10 meters (25-30 ft) tall. Radiant heat from the sun is captured within the tower which generates a thermal gradient with hotter air in the upper regions of the tower. Food waste is passed through a commercial shredder to increase surface area. The shredded waste is transported to the upper level of the tower via a diagonal conveyor. The waste is then dropped onto a cascading series of horizontal conveyor belts within the tower. These conveyor belts are situated such that when the food waste reaches the end of one belt it is dropped onto another conveyor below it. The food waste is guided by bumpers to ensure it stays on the conveyors. This drop serves to mix the waste to expose all sides to the air to enhance the desiccation rate. The lowest conveyor belt transports the dried food waste outside where it is collected and stored.

Some pathogens existing on the food waste will be killed by the drying process. However, the dried food product and the reclaimed water should be tested regularly for pathogen load. Sensors located on all conveyor belts as well as inside and outside the tower monitor the temperature, relative humidity, and water content of the food waste. Information from the sensors is received by a control program that regulates the speed of the conveyors to optimize drying rates: on hot dry days the conveyors will move faster than on cooler cloudy days. A computer-controlled variable-speed fan can facilitate drying time by distributing hot air throughout the tower.

The drying tower utilizes radiant heat to dry the food waste minimizing energy costs compared to current technologies of food drying. The energy required to run the motors and water condensers is provided by solar panels or thin-film photovoltaics. A heat sink largely external but adjacent to the tower, may trap additional radiant heat that can then be released into the tower after sunset to prolong drying time. In some embodiments, water may be used as a heat sink. The solar drying tower can be optimized for different climatic zones. Cooler and cloudier climate zones will need a higher retention time of the food waste in the system. Hot and dry zones will need a shorter retention time. Retention time of the food waste in the tower is an important factor in drying efficiency: too short a retention time and the food waste will not completely dry, too long a retention time will decrease the volume that can be processed. Retention time of the food waste can be manipulated and optimized in a number of ways such as the overall length of the conveyor system, the speed of the conveyor, the height of the tower, as examples.

The US produces about two billion wet-weight tons of livestock manure per year. The processing of this waste is of significant concern. The solar tower may help alleviate this by drying the manure (2 billion tons wet weight are about 335 million tons dry-weight). Drying the manure reduces transport costs, smell, pathogens, and allows the manure to be more easily stored.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

The reference numbers recited in the below claims are solely for ease of examination of this patent application, and are exemplary, and are not intended in any way to limit the scope of the claims to the particular features having the corresponding reference numbers in the drawings.

1. A system (100) for drying organic matter, the system (100) comprising:
a. a solar tower (110) clad in a transparent or translucent covering, comprising a hollow interior to allow components to be disposed within the solar tower (110);
b. a conveyor system disposed within the solar tower (110), wherein the conveyor system is configured to transport the organic matter within the hollow interior of the solar tower (110);
c. a plurality of sensors (220) disposed on the conveyor system, within the solar tower (110) and on an exterior of the solar tower (110), and operatively coupled to a control system for collecting information comprising temperature, relative humidity, water content of the organic matter, and providing the information to the control system as appropriate for weather conditions and the organic matter; and
d. the control system operatively connected to the conveyor system, the control system configured to control transportation of the organic matter via the conveyor system, a plurality of water condensers and a plurality of fans such that the organic matter is dried;
wherein sunlight causes a thermal gradient within the hollow interior, causing air in an upper portion of the hollow interior to be hotter than air in a lower portion of the hollow interior.

2. The system (100) of claim 1, wherein the system is configured to dry either a continuous flow of organic matter or a batch of organic matter.

3. The system (100) of claim 1, wherein the conveyor system comprises one or more conveyors (210).

4. The system (100) of claim 3, wherein the conveyor system comprises at least one of a linear conveyor, a spiral conveyor, an elevator, a chute, or a mobile conveyor container.

5. The system of claim 3, wherein two or more components of the conveyor system are powered by a shared motor.

6. The system (100) of claim 1, wherein two or more components of the conveyor system convey the organic matter at different speeds.

7. The system (100) of claim 1, wherein the conveyor system is configured to transport the organic matter from the lower portion of the hollow interior to the upper portion of the hollow interior.

8. The system (100) of claim 1, wherein the conveyor system is configured to transport the organic matter from the upper portion of the hollow interior to the lower portion of the hollow interior.

9. The system (100) of claim 1, additionally comprising one or more fans (500) configured to circulate air from the upper portion of the hollow interior to the lower portion of the hollow interior or from the lower portion of the hollow interior to the upper portion of the hollow interior.

10. The system (100) of claim 9, the one or more fans (500) are configured to circulate air within the hollow interior of the solar tower (110) or between the hollow interior of the solar tower (110) and an exterior of the solar tower (110).

11. The system (100) of claim 1, wherein the system (100) is configured to produce usable water.

12. The system (100) of claim 11, wherein the system (100) additionally comprises a moisture collection system configured to condense moisture within the hollow interior of the solar tower (110) and transport the condensed moisture to a water storage (410).

13. The system (100) of claim 1, wherein the organic matter comprises an agricultural product, food waste, or manure.

14. The system (100) of claim 1, additionally comprising one or more mixing components (225) configured to mix the organic matter as it is transported by the conveyor system.

15. A method for drying organic matter, the method comprising:
a. providing a solar tower (110) in which sunlight causes a thermal gradient within the hollow interior, causing air in an upper portion of the hollow interior to be hotter than air in a lower portion of the hollow interior;
b. transporting the organic matter to a conveyor system disposed within the solar tower (110); and
c. transporting the organic matter throughout the hollow interior via the conveyor system such that the organic matter is exposed to the thermal gradient for a sufficient period of time to achieve a desired degree of dehydration.

16.-19. (canceled)

20. The method of claim 15, wherein all of the energy required for heating the solar tower is generated by harnessing solar power.

21-40. (canceled)

41. The method of claim 15, wherein the solar tower further comprises a plurality of sensors (220) disposed on the conveyor system, within the solar tower (110) and on an exterior of the solar tower (110), operatively coupled to a control system for collecting information, wherein the control system is configured to receive the information from the plurality of sensors (220) and use the information to determine a speed of the conveyor system, speed of fans, and operation of a water condenser system.

42. The system of claim 1 further comprising a solar power system for converting sunlight into power for the conveyor system, the plurality of sensors (220), the plurality of water condensers, the plurality of fans, and the control system.

43. The system of claim 1, wherein the information collected by the plurality of sensors (220) comprises temperature inside and outside the solar tower (110), relative humidity, and water content of the organic matter.

44. The system of claim 1 further comprising a heat sink (600) disposed adjacent to an external surface of the solar tower (110) for trapping additional radiant heat to be released into the solar tower (110) after sunset to prolong drying time.
